(19) United States
(12) Patent Application Publication
(10) Pub. No.: US 2018/0015434 A1
(43) Pub. Date: Jan. 18, 2018

(54) STUFFING SCREW

(71) Applicant: ARLANXEO Deutschland GmbH, Dormagen (DE)

(72) Inventors: Joerg KIRCHHOFF, Cologne (DE); Thomas KOENIG, Leverkusen (DE); Michael BIERDEL, Leverkusen (DE)

(73) Assignee: ARLANXEO Deutschland GmbH, Dormagen (DE)

(21) Appl. No.: 15/547,877

(22) PCT Filed: Jan. 21, 2016
(86) PCT No.: PCT/EP2016/051220

§ 371 Date: Aug. 1, 2017

(30) Foreign Application Priority Data
Feb. 6, 2015 (EP) 15154095.2

(51) Int. Cl. B01F 15/00; B01F 7/00; B01F 7/08

(52) U.S. Cl. CPC B01F 15/00993; B01F 7/082; B01F 7/00816; B01F 2215/0049

(57) ABSTRACT

A stuffing screw (2) for use in an extruder system comprises a housing (7) and at least one conveying screw (5), which is mounted in a rotatable manner within the housing (7), wherein a conveying space is formed between an inner side of the housing (7) and the conveying screw (5). The stuffing screw (2) is characterized in that at least one portion of the inner side of the housing (7) is provided with one or more depressions, in particular in the form of a groove (13).

The invention relates to a stuffing screw for an extruder system and to an extruder system having such a stuffing screw.

Extruders serve for producing strands from formable materials, wherein, within the extruder, the materials are mixed, often plasticated and driven out of a nozzle under high pressure in order for the material strands to be generated.

Extruders can be differentiated basically into two types, which differ in terms of the process principles. Processing extruders serve predominantly for shaping purposes (usually single shaft extruders), whereas compounding extruders serve for the chemical and/or physical modification (reacting, mixing, degassing, etc.) of substances (double-shaft extruders with shafts closely intermeshing and running in the same direction, Buss kneaders, etc.).

Stuffing screws (also providing a holding-down function) are used as secondary subassemblies on an extruder. The stuffing screws are basically conveying screws. These are used predominantly for two purposes. On the one hand, said stuffing screws serve to meter a product or additives into the extruder. On the other hand, stuffing screws also prevent product discharge from the extruder at extruder-housing openings which serve, for example, for ventilating or degassing purposes.

In the case of degassing in an extruder, the vapors and gases separated oft (the so-called vapor flow) have to be extracted from the product space. It is often the case here that very high gas speeds prevail. Moreover, product particles are produced in the case of degassing in the extruder as a result of the expansion and of foaming of the materials. This effect occurs particularly in the case of the degassing of highly viscoelastic materials, in particular elastomers. The resulting product particles can have a wide range of sizes, which can regularly extend from <0.1 mm up to a number of millimeters. As a result of the high gas speeds, the product particles can be discharged from the extruder with the vapor flow. Using a stuffing screw in the degassing opening, then, on the one hand prevents blockage of the degassing opening. On the other hand, the stuffing screw serves to separate off entrained product particles from the vapor flow. This is intended to protect downstream subassemblies, e.g. separators, extraction systems, vacuum systems or condensate systems, against deposits of product. Otherwise, a pronounced discharge of product particles into the downstream subassemblies would result in, for example, separators having to be frequently cleaned, vacuum pumps being damaged or condensate systems becoming blocked and thus suffering a loss in efficiency.

In tests for degassing rubber, it has been found that a large quantity of product particles is discharged despite the stuffing screws. Closer observations have shown that, as a result of the high gas speeds in the threads of the stuffing screw, the product particles, rather than adhering to the profile flanks or to the housing of the stuffing screw, are thrown back from the wads. In the case of viscoelastic materials, e.g. rubber, being handled, this effect is intensified by the high level of elasticity of the particles. The adhesion forces are then not large enough to overcome the rebound effect.

Proceeding from this prior art, the object of the invention was to improve the function of a stuffing screw, in particular in the case of degassing in an extruder. In particular, a discharge of product particles via the stuffing screw should be reduced.

This object is achieved by the subjects of the independent patent claims. Advantageous embodiments form the subject matter of the respective dependent patent claims and can be gathered from the following description of the invention.

The invention was based on the idea of reducing a discharge of product particles via the stuffing screw in that in the first instance said product particles are separated off from the vapor flow and then the separated-off product particles are agglomerated. The intention is then for the agglomerated product particles to be guided back into the extruder or discharged from the extruder system in a reliable manner, i.e. not via the venting system which adjoins the stuffing screw.

This basic idea of the invention is implemented according to the invention in that a stuffing screw which is intended for an extruder and comprises at least one housing and at least one conveying screw, which is mounted in a rotatable manner within the housing, wherein a conveying space is formed between an inner side of the housing and the conveying screw, has at least one portion of the inner side of the housing provided with one or (preferably) more depressions.

“Depressions” according to the invention are considered to be those which have a dosed base, as a result of which they are distinguished from openings such as are also present as functional openings in conventional stuffing screws.

It is possible for the depressions to be of any desired cross-sectional shape and to be provided in organized or non-organized form in the inner side of the housing

The depressions ensure that low-gas-speed stagnation zones are produced on the inner side of the housing. The speed of the product particles entrained by the gas decreases in these stagnation zones, and this makes it possible for particles to be is deposited in the groove. The depressions also have the advantage that the product particles can agglomerate therein. The agglomerates are then no longer entrained by the gas flow and can either be conveyed back into the extruder or discharged in a reliable manner.

It is particularly preferable for the depression(s) to be designed in the form of a (at least one groove).

“Groove” is understood, according to the invention, to be a depression which is located on the inner side of the housing and of which the length is preferably greater, and in particular a number of times greater, than its width.

Provision may be made for the depressions or the groove to be provided over (essentially) the entire length of the inner side of the housing. It may also be advantageous, however, for the depressions or the groove to be provided just in one or more portions of the inner side of the housing. Interrupting a groove can ensure further disruption of the gas flow, said disruption helping to separate off entrained product particles. It is possible for the depressions or the plurality of grooves in the various portions to be of the same shape (groove progression, groove width, groove cross section) or else to be designed differently. In the case of a continuous groove, provision may likewise be made for the groove shape to be of constant or variable design.

In a preferred embodiment of the stuffing screw according to the invention, provision may be made for the groove to run (essentially) parallel to the longitudinal axis of the stuffing screw. This is a straightforward and therefore relatively cost-effective possible realization. A parallel progression of the groove, however, can also be distinguished by agglomerates which are formed in the grooves being removed to particularly good effect.

Provision may particularly preferably be made, however, for the groove to run helically.

Provision can then preferably be made for the direction of pitch (right-hand pitch, left-hand pitch) of the groove to be counter to the direction of pitch of a (at least one) helically running thread of the conveying screw. It is particularly preferably possible is here to provide an angle ranging from 70° to 110° between the groove and the thread (as seen in relation to the longitudinal direction of the conveying screw). This can have the advantage that a main direction of flow of the gas flow in the thread is (more or less) perpendicular to the groove, and this helps to separate off the product particles. Furthermore, the task of conveying the agglomerates out of the grooves can be improved as a result.

An alternative embodiment can provide for the direction of pitch of the thread and of the groove to be identical. This means that the groove and the thread run more or less parallel. In particular in a combination with a triangular cross section of the groove, this arrangement can have the advantage that agglomerates can be conveyed out of the grooves to particularly good effect as a result of which the risk of “caking” or of the groove gradually “blocking up” is reduced.

Of course, it is also possible to combine the two alternatives, in order then to provide at least two helically running grooves which have opposite directions of pitch and therefore cross over. This makes it possible to achieve a combination of the advantages of the two groove progressions.

Provision may &so be made for the pitch of the groove to be non-uniform, i.e. for it not to be constant. In the case of at least two helical grooves, it is also possible for the individual grooves to have different pitches and different numbers of windings.

The configuration of a stuffing screw according to the invention improves, in particular, the task of separating off product particles from the gas flow when use is made of the stuffing screw for degassing an extruder of an extruder system, and therefore provision is preferably made for the stuffing screw or the housing thereof to have at least one degassing outlet, to which can be connected a degassing system with the components which are known from the prior art. However, the configuration of the stuffing screw according to the invention also has an advantage in terms of conveying material, and therefore said stuffing screw is also advantageously suitable for use for metering material into the extruder.

An extruder system according to the invention comprises at least one extruder and at least one stuffing screw as have been described above. The extruder comprises at least one extruder housing and an (at least one) extruder screw, which is mounted in a rotatable manner in the extruder housing. The stuffing screw adjoins the extruder preferably in a transverse direction and particularly preferably in a perpendicular direction, as seen in relation to the longitudinal axis of the extruder.

The extruder may be any known type of extruder, in particular in the form of single-shaft extruders, double-shaft extruders (with shafts rotating in the same direction or opposite directions and meshing or not meshing), multi-shaft extruders (e.g. ring extruders), planetary roller extruders and co-kneaders with an axially oscillating shaft. The extruder may likewise be in the form of any desired design of kneader (even a large-volume one) with one or more shafts. It is preferred, however, for the extruder to be configured in the form of a single-shaft extruder or a double-shaft extruder with shafts rotating in the same direction.

The stuffing screw according to the invention is also suitable, in particular, for degassing highly viscoelastic material, in particular an elastomer (e.g. rubber), conveyed in an extruder.

The invention will be explained in more detail hereinbelow with reference to exemplary embodiments illustrated in the drawings, in which:

FIG. 1 shows a schematic illustration of a first embodiment of an extruder system according to the invention;

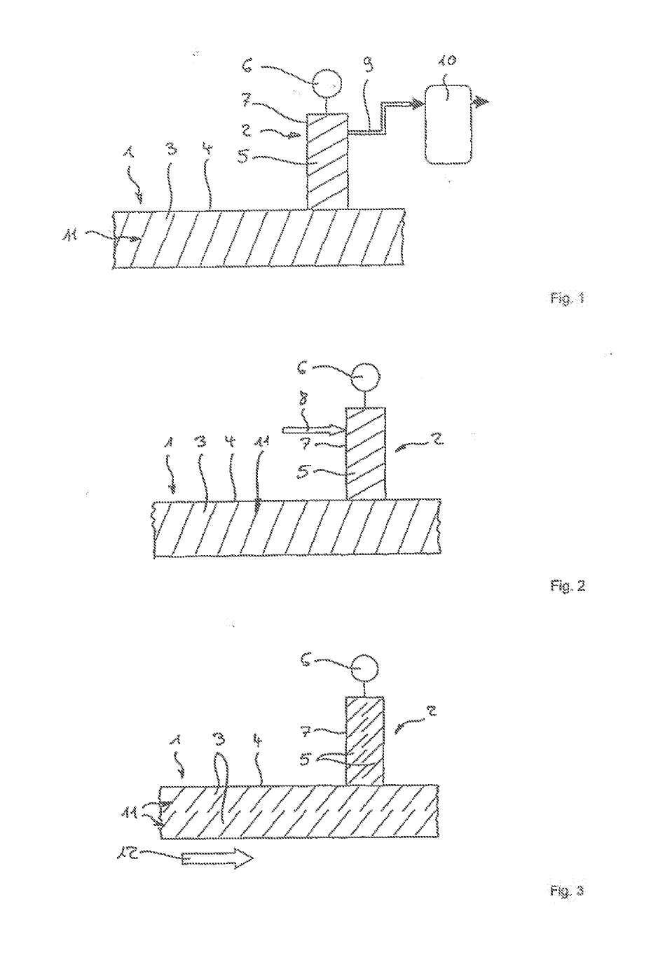

FIG. 2 shows a schematic illustration of a second embodiment of an extruder system according to the invention;

FIG. 3 shows a schematic illustration of a third embodiment of an extruder system according to the invention;

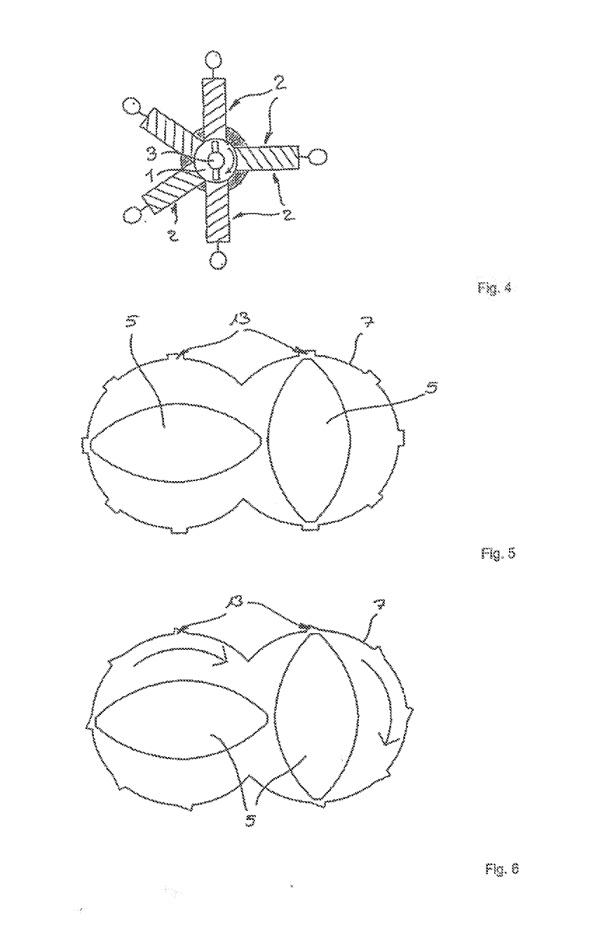

FIG. 4 shows various possible way of integrating a stuffing screw in an extruder system according to the invention;

FIG. 5 shows a first groove shape for a stuffing screw according to the invention;

FIG. 6 shows a second groove shape for a stuffing screw according to the invention;

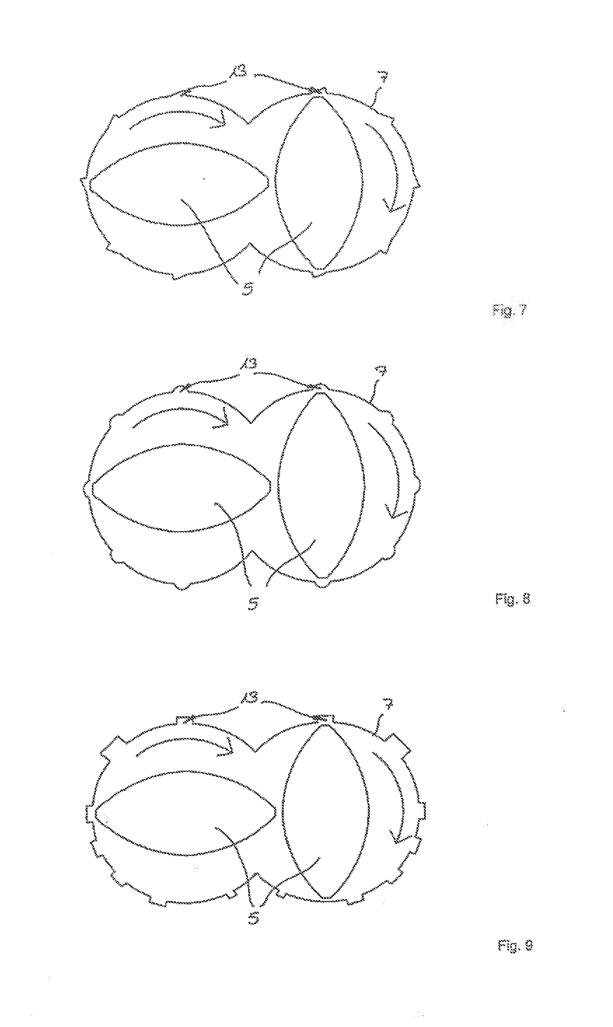

FIG. 7 shows a third groove shape for a stuffing screw according to the invention;

FIG. 8 shows a fourth groove shape for a stuffing screw according to the invention;

FIG. 9 shows a fifth groove shape for a stuffing screw according to the invention;

FIG. 10 shows a first groove progression for a stuffing screw according to the invention;

FIG. 11 shows a second groove progression for a stuffing screw according to the invention;

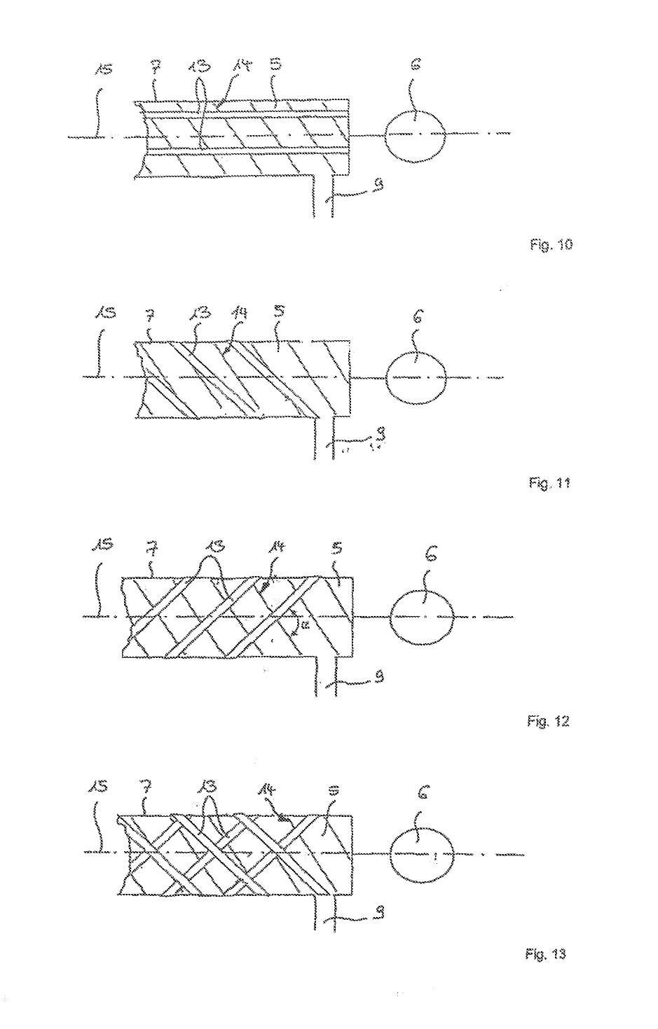

FIG. 12 shows a third groove progression for a stuffing screw according to the invention; and

FIG. 13 shows a fourth groove progression for a stuffing screw according to the invention.

An extruder system according to the invention has an extruder 1 and at least one stuffing screw 2 connected thereto. The extruder 1 comprises an extruder screw 3, which is mounted in an extruder housing 4 so as to be driven in rotation by a drive (not illustrated). The stuffing screw 2 comprises a conveying screw 5, which is mounted in a housing 7 so as to be driven in rotation by a drive 6. It is possible for the extruder 1 to have, for example, a single extruder screw 3 and for the stuffing screw 2 to have a single conveying screw 5, as is illustrated by way of example in FIGS. 1 and 2. It is likewise possible for the extruder 1 to be designed with a plurality of extruder screws 3 and for the stuffing screw 2 to be designed with a plurality of conveying screws 5. FIG. 3 shows, by way of example, the configuration of an extruder system according to the invention having two extruder screws 3 and two conveying screws 5. In configurations with more than one conveying screw 5, designs in which the screws are closely intermeshing and rotate in the same direction or in opposite directions are preferred according to the invention.

The stuffing screw 2 of an extruder system according to the invention may be provided as a feeding mechanism, via which a product and/or one or more additives are/is fed to the product already located in the extruder 1. FIG. 2 shows, by way of example, a corresponding configuration of an extruder system according to the invention having an inlet 8 in a housing 7 of the stuffing screw 2, the product being fed via said inlet,

The stuffing screw 2 may also be provided for the purpose of degassing the extruder 1 (cf. FIG. 1). In this case, the housing 7 of the stuffing screw is provided with an outlet 9 for connection to an extraction system 10.

In the annular product space formed between the extruder screw(s) 3 and the extruder housing 4, the product is transported in the direction denoted by the arrow 12, and possibly mixed, plasticated and compressed in the process, by the rotation of the extruder screw(s) 3, designed with helically running threads 11. The inner volume of the extruder housing 4 and the inner volume of the housing 7 of the stuffing screw 2 are connected to one another, and therefore a product which is fed via the stuffing screw 2 can be introduced into the extruder 1 and gas which has formed in the extruder 1 can be discharged via the stuffing screw 2.

The stuffing screw 2 can be connected to the extruder 1 in any desired orientation. FIG. 4 shows various orientations for the stuffing screws 2. In addition to vertically downward or upward and horizontally (to the right or left), it is also possible for the stuffing screw to be oriented obliquely upward or obliquely downward (as seen in relation to the direction of gravity in each case). Horizontal or vertical (in particular vertically upward) arrangements are preferred. FIGS. 1 to 3 show embodiments in which the stuffing screw 2 is arranged in each case perpendicularly in relation to the longitudinal axis of the extruder 1. As an alternative to this, of course, it is also possible for the stuffing screw 2 to be connected to the extruder 1 such that Its longitudinal axis encloses with the longitudinal axis of the extruder 1 an angle which, rather than being 90°, is between 0 and <90°, for example 45°.

Should a plurality of stuffing screws 2 be combined on an extruder 1, then they can be provided at different axial positions as seen in relation to the longitudinal axis of the extruder 1. It is also possible for a plurality of stuffing screws 2 to be arranged is with different radical orientations at one axial position of the extruder 1 (cf, FIG. 4), so as to increase, for example, the free flow cross sections available.

FIGS. 5 to 9 show, schematically, different cross sections with which the grooves 13 of stuffing screws 2 according to the invention (here, by way of example, with two conveying screws 5 with the same direction of rotation) can be formed. FIG. 5 here shows a rectangular cross section for the grooves 13, and FIGS. 6 and 7 show triangular cross sections for the grooves 13. The triangular cross sections are not Isosceles, wherein, in the case of the embodiment of FIG. 6, the longer, flatter limb is located at the rear in the direction of rotation of the conveying screws 5 (“petering out in the direction of rotation”), whereas, in the case of the embodiment of FIG. 7, the shorter, steeper limb is located at the rear in the direction of rotation of the conveying screws 5 (“falling away in the direction of rotation”). Of course, it is also possible for the triangular cross section of the grooves 13 to be isosceles or equilateral. The cross section of the grooves 13 in the case of the embodiment of FIG. 8 is curved and, in particular, in the form of part of a circle. FIG. 9, in addition, also shows the possibility of forming the grooves 13 with irregular spacings and/or a non-uniform cross section (in respect of the dimensions and/or in respect of the cross-sectional shape).

FIGS. 10 to 13 show various possible progressions of grooves 13 of stuffing screws 2 according to the invention. The embodiment of FIG. 10 provides for the grooves 13 to be oriented parallel to the longitudinal axis 15 of the stuffing screw 2 or of the conveying screw 5. This is a straightforward and therefore technically cost-effective solution, in particular in the case of a combination with the groove shape according to FIG. 6, it is also possible, however, for the parallel arrangement to be distinguished by agglomerates which are formed in the grooves 13 being removed to particularly good effect. This can reduce the risk of “caking” in the grooves 13 or of the grooves 13 gradually “blocking up”.

In the case of the embodiment of FIG. 11, the grooves 13 of the stuffing screw 2 run helically, to be precise with the same direction of pitch (right-hand direction) as the likewise helically running threads 14 of the conveying screw 5. The grooves 13 and the threads 14 therefore run more or less parallel.

In contrast to this, the embodiment of FIG. 12 makes provision for the helically running grooves 13 to have a direction of pitch which is counter to that of the threads 14 of the conveying screw 5. Provision is preferably made here for the angle α enclosed by the grooves 13 and the threads 14 over the longitudinal axis 15 of the stuffing screw 2 to range between 70° and 110°.

FIG. 13, finally, shows a combination of grooves 13 which cross over as a result of opposite directions of pitch.

### LIST OF REFERENCE SIGNS

1 Extruder

2 Stuffing screw

3 Extruder screw

4 Extruder housing

5 Conveying screw

6 Drive

7 Housing

8 inlet

9 Outlet

10 Extraction system

11 Thread

12 Transporting direction

13 Groove

14 Thread

15 Longitudinal axis

1. A stuffing screw comprising:
a housing; and
at least one conveying screw, which is mounted in a rotatable manner within the housing,
wherein a conveying space is formed between an inner side of the housing and the conveying screw, and at least one portion of the inner side of the housing comprises one or more depressions extending radially outwardly away from the conveying screw.

2. The stuffing screw as claimed in claim 1, wherein each of the one or more depressions comprise a groove having a longitudinal direction and a cross-sectional dimension orthogonal to the longitudinal direction.

3. The stuffing screw as claimed in claim 1, wherein the conveying screw has a longitudinal axis and the housing comprises at least two depressions spaced apart from one another in the direction of the longitudinal axis of the conveying screw.

4. The stuffing screw as claimed in claim 2, wherein the groove runs parallel to the longitudinal axis of the conveying screw.

5. The stuffing screw as claimed in claim 2, wherein the groove runs helically with respect to the longitudinal axis of the conveying screw.

6. The stuffing screw as claimed in claim 5, wherein the conveying screw has at least one helically running thread disposed about the longitudinal axis thereof, and the direction of pitch of the thread is counter to the direction of pitch of the groove.

7. The stuffing screw as claimed in claim 6, wherein the groove and the thread define an angle (α) of 70° to 110° as seen in the direction of the longitudinal axis of the conveying screw.

8. The stuffing screw as claimed in claim 5, wherein the conveying screw has at least one helically running thread disposed about the longitudinal axis thereof, and the direction of pitch of the thread and the direction of pitch of the groove are identical.

9. The stuffing screw as claimed in claim 5, the pitch of the helically running groove is non-uniform.

10. The stuffing screw as claimed in claim 5, wherein the inner side comprises a plurality of spaced apart depressions, each depression comprising a helically running groove, wherein the helically running grooves comprise different directions of pitch, pitches and/or numbers of windings.

11. The stuffing screw as claimed in claim 2, further comprising a degassing outlet.

12. An extruder system comprising an extruder, and a stuffing screw as claimed in claim 2.

13. The extruder system as claimed in claim 12, wherein the stuffing screw further comprises a degassing outlet.

14. A method of degassing viscoelastic material conveyed in an extruder, the method comprising conveying, the viscoelastic material through the extruder system as claimed in claim 13, and degassing the viscoelastic material.

15. A conveying screw assembly comprising:
a housing defining a longitudinal direction and a radial direction orthogonal to the longitudinal direction; and
at least one conveying screw mounted in a rotatable manner within the housing for conveying material through the housing in the longitudinal direction of the housing, the conveying screw having a longitudinal axis parallel to the longitudinal direction of the housing;
wherein the housing comprises an interior surface disposed towards and at least partially about the at least one conveying screw, wherein the interior surface comprises at least one groove extending along at least a portion of the interior surface and at an angle to the radial direction.

16. The conveying screw assembly according to claim 15, wherein the groove has a longitudinal dimension, and at least portions thereof run parallel to the longitudinal axis of the conveying screw or helically with respect to the longitudinal axis.

17. The conveying screw assembly according to claim 16, wherein the groove has a cross-sectional configuration orthogonal to the longitudinal direction, and the cross-sectional configuration comprises at least one of: a rectangular configuration; a triangular configuration; and a semi-circular configuration.

18. The conveying screw assembly according to claim 17, wherein the interior surface comprises a plurality of spaced apart helically running grooves, wherein the helically running grooves comprise different directions of pitch, pitches and/or numbers of windings.

19. The conveying screw assembly according to claim 17, wherein:
the interior surface comprises a plurality of spaced apart helically running grooves, wherein the helically running grooves are one of: regularly spaced or irregularly spaced, along the circumferential and axial directions of the interior surface; and
the cross-sectional configuration for each groove is one of: the same as or different from the cross-sectional configuration of another groove; and
for each groove, the cross-sectional configuration is one of: the same or different along the entire length of the groove.
